(19) United States
(12) Patent Application Publication
(10) Pub. No.: US 2012/0027994 A1
(43) Pub. Date: Feb. 2, 2012

(54) TRANSPARENT CONDUCTIVE FILM AND METHOD FOR MANUFACTURING TRANSPARENT CONDUCTIVE FILM

(75) Inventors: Hiroshi Takada, Tokyo (JP); Hirokazu Koyama, Tokyo (JP)

(73) Assignee: KONICA MINOLTA HOLDINGS, INC., Tokyo (JP)

(21) Appl. No.: 13/256,348

(22) PCT Filed: Mar. 1, 2010
(86) PCT No.: PCT/JP2010/053218

§ 371 Date: Sep. 13, 2011

(30) Foreign Application Priority Data
Mar. 17, 2009 (JP) 2009-064102

(51) Int. Cl. B32B 3/00; H01B 13/00; B82Y 30/00

(52) U.S. Cl. 428/141; 216/20; 977/762

(57) ABSTRACT

Provided is a low-cost transparent conductive film which has high optical transparency and excellent surface conductivity and surface smoothness. A method for manufacturing such transparent conductive film is also provided. The transparent conductive film has, on a transparent base material, a conductive fiber layer which includes at least a transparent resin and a conductive fiber. At least a part of the conductive fiber is exposed from the surface of the transparent conductive film, and the relationship between the surface roughness (Rz) of the transparent conductive film and the average diameter (D) of the conductive fiber satisfies the inequalities of 0<Rz<D.

### TECHNICAL FIELD

The present invention relates to a transparent conductive film which can be suitable used for a transparent electrode of a various kinds of optoelectronics devices such as liquid crystal display elements, organic luminescence elements, inorganic electroluminescence elements, solar cells, electromagnetic wave shields, electronic papers and touch panels. This transparent conductive film has high surface conductivity and high transparency, and it has excellent surface smoothness. In addition to that, the present invention relates to a method for manufacturing the same transparent conductive film provided with the above-described characteristics enabling to reduce the manufacturing cost to a large extent.

### BACKGROUND

In recent years, along with an increased demand for thinner TVs and large format TVs, there have been developed display technologies of various systems such as liquid crystals, plasma, organic electroluminescence, and field emission. In any of the displays which differ in the display system, transparent electrodes are incorporated therein as an essential constituting technology. Further, other than TVs, in touch panels, cellular phones, electronic paper, various solar cells, and various electroluminescence controlling elements, transparent electrodes have become an indispensable technical component.

Conventionally, as a transparent electrode, there has been mainly used an ITO transparent electrode having an indium-tin complex oxide (ITO) membrane produced by a vacuum deposition method or a sputtering process on transparent substrates, such as glass and a transparent plastic film. However, there were problems that a manufacturing cost was high since the metal oxide transparent conductive film manufactured using a vacuum processes, such as a vacuum deposition method and a sputtering process, was inferior with respect to manufacturing efficiency, and that it was inapplicable to the device application required to have a flexible nature since it was inferior with respect to flexibility.

The technologies using a conductive fiber such as a carbon nanotube (CNT) or a metal nanowire was disclosed to the above-mentioned problems. These techniques aim at acquiring optical transmittance and conductivity equivalent to or more than ITO, by forming fine and dense conductive network structure using a conductive fiber of nano size, such as a carbon nanotube or a metal nanowire which has conductivity equivalent to or more than ITO and which are also excellent in optical transmittance.

For example, in Patent document 1 and Patent document 2, there was proposed a method to apply a conductive fiber on a substrate and then to laminate a transparent resin to have the thickness so that a part of conductive fiber projects on a surface to result in fanning a transparent conductive film. However, in the transparent conductive film of such composition, since the conductive fiber surface will be covered with the transparent resin, or since the conductive fiber was buried in the transparent resin layer, sufficient surface conductivity for functioning as a transparent electrode was not able to be acquired. In addition, since the conductive fiber projected on the top side, it also had a problem that it cannot be applied to the technical application asked for the surface smoothness of an electrode surface.

Moreover, in the above-mentioned patent document 1 or patent document 2, there was also proposed a method for forming a transparent conductive film. This method contains: to prepare an adhesive layer on a conductive fiber layer which has been formed on a peeling film; then to pressure transfer the conductive fiber layer by sticking onto other substrate. However, by this way, since the adhesive layer penetrate into the space between the peeling film and the conductive fiber, the surface of the transparent conductive film after the transfer will be covered by the adhesive layer, sufficient surface conductivity for functioning as a transparent electrode was not be able to be obtained

Furthermore, in the above-mentioned patent document 1, it was also proposed a method in which a conductive fiber was buried in a substrate by a roll press after forming a conductive fiber layer on a soft substrate. However, this method has a problem that durability and stability were insufficient since the surface smoothness of the electrode surface was insufficient, or the adhesion property between the substrate and the conductive fiber was not enough.

### PRIOR ART DOCUMENTS

### Patent Documents

Patent document 1: (Japanese translation of PCT international application) JP-A No. 2006-519712
Patent document 2: US 2007/0074316

### SUMMARY OF THE INVENTION

### Problems to be Solved by the Invention

As mentioned above, it was not able to obtain a transparent conductive film which satisfies the various characteristics required by using the technologies previously proposed. Therefore, an object of the present invention is to provide a transparent conductive film having high optical transmittance and excellent in surface conductivity and surface smoothness with low cost. And, an object of the present invention is also to provide a method for producing such transparent conductive film.

### Means to Solve the Problems

The present inventors carried out investigations to solve the problems of the transparent conductive film which used a conductive fiber such as a carbon nanotube and a metal nanowire. Particularly, the present inventors investigated repeatedly to realize excellent surface conductivity and high surface smoothness. As a result, it was found that a transparent conductive film having high optical transmittance with excellent surface conductivity and excellent surface smoothness can be realized by the following method. The method contains: to form a conductive fiber layer containing a conductive fiber and a soluble binder on a mold-releasing substrate; to transfer the conductive fiber layer to a transparent substrate by using a transparent resin as an adhesive agent to result in forming a transparent conductive film; then to remove at least a part of the soluble binder from the surface of the formed transparent conductive film.

In the production method of the transparent conductive film of the present invention, a vacuum process is not required as for forming ITO transparent conductive film. As a result, it is possible to reduce the production cost of a transparent conductive film to a large extent.

The present inventors achieved the present invention by acquiring the above-mentioned knowledge. That is, the above-mentioned problems concerning the present invention are resolved by the following means.

1. A transparent conductive film comprising a transparent substrate having thereon a conductive fiber layer containing at least a transparent resin and a conductive fiber, wherein at least a part of the conductive fiber is exposed on a surface of the transparent conductive film, and a relationship between a surface roughness (Rz) of the transparent conductive film and an average diameter (D) of the conductive fiber satisfies the inequalities of 0<Rz<D.
2. The transparent conductive film described in the aforesaid item 1, wherein the conductive fiber is selected from the group consisting of metal nanowires.
3. A method of producing the transparent conductive film described in the aforesaid items 1 or 2 comprising the steps of:

forming a conductive fiber layer containing a conductive fiber and a soluble binder on a mold-releasing surface of a mold-releasing substrate;

transferring the conductive fiber layer onto a transparent substrate using an adhesive agent to form a transparent conductive film; then

removing at least a part of the soluble resin from a surface of the transparent conductive film.

4. A method of producing the transparent conductive film described in the aforesaid item 3, wherein a relationship between a thickness (d) of the conductive fiber layer formed by the soluble binder and the average diameter (D) of the conductive fiber satisfies the inequalities of 0<d<D.

### Effect of the Invention

According to the above-mentioned composition of the present invention, it can realize a transparent conductive film which has high optical transmittance and excellent in surface conductivity and surface smoothness with low cost. As a result, it is possible to provide a transparent electrode suitably applicable to a technical application such as a current driving type optoelectronics device or an organic electroluminescence device which is asked for low surface resistivity and high surface smoothness. Moreover, since the transparent conductive film of the present invention can be composed of a film substrate, it is suitably applicable to technical applications, such as a mobile optoelectronics device which is asked for a light weight or flexibility. In addition, since the production method of the transparent conductive film of the present invention does not need a vacuum process needed for the production of a conventional ITO electrode, manufacturing efficiency can be improved, and there is also little energy consumption and it excels also in environmental aptitude.

### BRIEF DESCRIPTION OF THE DRAWINGS

FIG. 1 is a schematic drawing showing the section structure of the transparent conductive film of the present invention.

FIG. 2 is an example of the way to determine the surface roughness (Rz) of the present invention from the height (Yp) of the summit, and the height (Yv) of a bottom of valley.

FIG. 3 is a schematic cross-sectional drawing showing the state of the conductive fiber on the surface of a transparent conductive film.

FIG. 4 is a drawing showing an example of the specific production process of the transparent conductive film of the present invention.

### EMBODIMENTS TO CARRY OUT THE INVENTION

The transparent conductive film of the present invention is a transparent conductive film having a transparent substrate on which a conductive fiber layer containing at least a transparent resin and a conductive fiber. At least a part of the conductive fiber is exposed to the surface of the transparent conductive film, and it is characterized in that the relationship between the surface roughness (Rz) of the transparent conductive film and the average diameter (D) of the conductive fiber is 0<Rz<D. This distinctive feature is a technical feature common to the invention concerning Claims 1 to 4.

In the present invention, “transparent” indicates a property which exhibits the total optical transmittance in the visible wavelength range of 60% or more when it is measured by the method based on “The test method of the total optical transmittance of a plastic transparent material” of JIS K 7361-1 (it corresponds to ISO 13468-1).

As one of the preferable embodiments of the transparent conductive film of the present invention, it can be cited an embodiment in which a conductive fiber is at least one sort chosen from the group of metal nanowires.

As a production method of a transparent conductive film of the present invention, the following method is preferable. Namely, a conductive fiber layer containing a conductive fiber and a soluble binder is formed on the mold-release surface of a mold-release characteristic substrate.

After transferring this conductive fiber layer on a transparent substrate using an adhesive agent to result in forming a transparent conductive film, then a target transparent conductive film is produced by removing at least a part of the soluble binder from the surface of the transparent conductive. Further, as another preferable embodiment of the method of producing the transparent conductive film of the present invention, it can be cited an embodiment in which the thickness (d) of the film formed with the soluble binder of the above-mentioned conductive fiber layer satisfies a relation of 0<d<D.

In the following, the present invention, the composing elements of the present invention and the best modes for carrying out the present invention will be described in details.

### [Transparent Conductive Film]

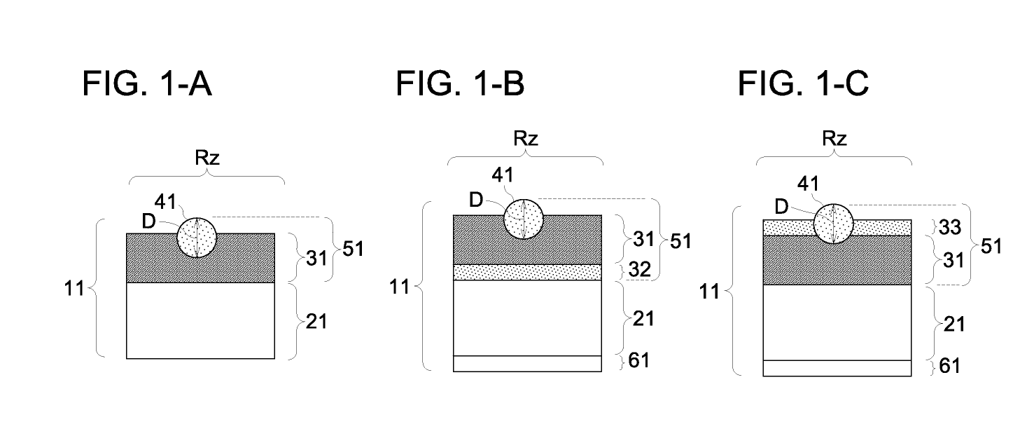

The schematic diagram of the sectional structure of the transparent conductive film of the present invention is shown in FIG. 1 (1-A). Transparent conductive film 11 of the present invention has conductive fiber layer 51 containing transparent resin layer 31 and conductive fiber 41 (the figure represents the section of the conductive fiber) on the transparent substrate 21. And it is characterized in that at least a part of the conductive fiber 41 is exposed to the surface of the transparent conductive film 11, and the surface roughness (Rz) of the transparent conductive film 11 satisfied the relationship of 0<Rz<D with respect to the average diameter (D) of the conductive fiber 41. However, there is no restriction in particular to other composing elements. For example, it can be a composition of the example shown in FIG. 1 (1-B) or FIG. 1 (1-C). It may have transparent resin layer 32 or transparent resin 33 layer each having a different composition from the transparent resin layer 31, or it may also have a various kinds of functional layer 61 according to the purpose.

The total optical transmittance of the transparent conductive film of the present invention is preferably at least 60%, it is more preferably at least 70%, but it is still most preferably at least 80%. It is possible to determine the total optical transmittance based on methods known in the art, employing a spectrophotometer. Further, the electrical resistance value of the transparent conductive film of the transparent electrode is preferably at most 1,000Ω/□ in terms of surface resistivity, it is more preferably at most 100Ω/□. In order to apply to electric current driving type optoelectronic devices, it is preferably to be at most 50Ω/□, and it is specifically preferable to be at most 10Ω/□. When the transparent conductive film has an electrical resistance value exceeding 1,000Ω/□, it may not function as a transparent electrode for a various kinds of electric current driving type optoelectronic devices. It is possible to determine the above surface resistivity, for example, based on JIS K7194: 1994 (test method for resistivity of conductive plastics with a 4-pin probe measurement method). Further, it is also possible to conveniently determine the surface resistivity employing a commercially available surface resistivity meter.

The thickness of the transparent conductive film of the present invention is not particularly limited, and it is possible to appropriately select the thickness depending on intended purposes. The thickness is preferably thinner since transparency and transparency are thereby improved in relation to the thickness, and commonly the thickness is preferably at most 1 mm. It is more preferably at most 500 μm, and more preferably at most 300 μm.

“The conductive fiber is exposed on the surface of a transparent conductive film” as used in the present invention means being in the state where it can be achieved electric contact with the conductive fiber in the surface of the transparent conductive film. For example, it is the case as shown in the above-mentioned FIG. 1 or FIG. 3 (3-A). On the other hand, as shown in FIG. 3 (3-B) or FIG. 3 (3-C), even if the conductive fiber exists on the surface of the transparent conductive film, when the surface of this conductive fiber is covered with an insulating transparent resin, the state of the conductive fiber does not correspond to the state of the present invention where it is exposed on the surface of the transparent conductive film. FIG. 3 is a schematic cross-sectional diagram showing the state of the conductive fiber on the surface of the conductive film.

In the present invention, the following method can be used for checking the state whether the conductive fiber is exposed on the surface of the transparent conductive film. That is, the etching treatment is carried out to the surface of the transparent conductive film using an etching solution which can dissolve a conductive fiber, and the exposure of the conductive fiber can be checked from the change of the surface resistivity of the transparent conductive film measured before and after the etching treatment. As shown in the above-mentioned FIG. 1 or FIG. 3 (3-A), when the conductive fiber is exposed to the surface, since the conductive fiber is directly exposed to an etching solution, the conductive fiber dissolves and disappears, and the surface resistivity of the transparent conductive film after the etching process increases. On the other hand, when the surface of the conductive fiber is covered with a transparent resin as shown in FIG. 3 (3-B) or FIG. 3 (3-C), the conductive fiber is not etched, as a result, the surface resistivity of the transparent conductive film does not change before and after the etching treatment.

In the present invention, the state in which the conductive fiber is exposed on the surface of the transparent conductive means the case where Ra/Rb≧10², wherein the surface resistivity before the etching process is set to be Rb and the surface resistivity after the etching process is set to be Ra. In the transparent conductive film of the present invention, it is preferable that Ra/Rb≧10⁴, and it is more preferable that Ra/Rb≧10⁶.

Since the surface resistance of the transparent conductive film of the present invention is preferably at most 1,000Ω/□ as describe above, the specific surface resistance after the etching treatment is preferably 10⁵Ω/□ or more, and it is more preferably 10⁷Ω/□ or more, and still more preferably, it is 10⁹Ω/□ or more.

Moreover, as another way to check the exposed state of the conductive fiber which exists on the surface of a transparent conductive film, it can be checked directly using the atomic force microscope (Atomic Force Microscope: AFM) which has a function of enabling to observe the conductivity of the surface of a sample. For example, NanoNavi probe station provided with Nano-Pico CURRENT/CITS mode and S-image high resolution small stage unit (made by Seiko Instruments Co., Ltd.) can be used. A specimen surface is scanned impressing a bias voltage (for example, 3V to 5V) between a conductive cantilever (for example, SI-DF3-R) and a specimen, and the electric current which flows between a cantilever and a specimen can be detected, and current distribution can be observed and checked.

### [Surface Smoothness]

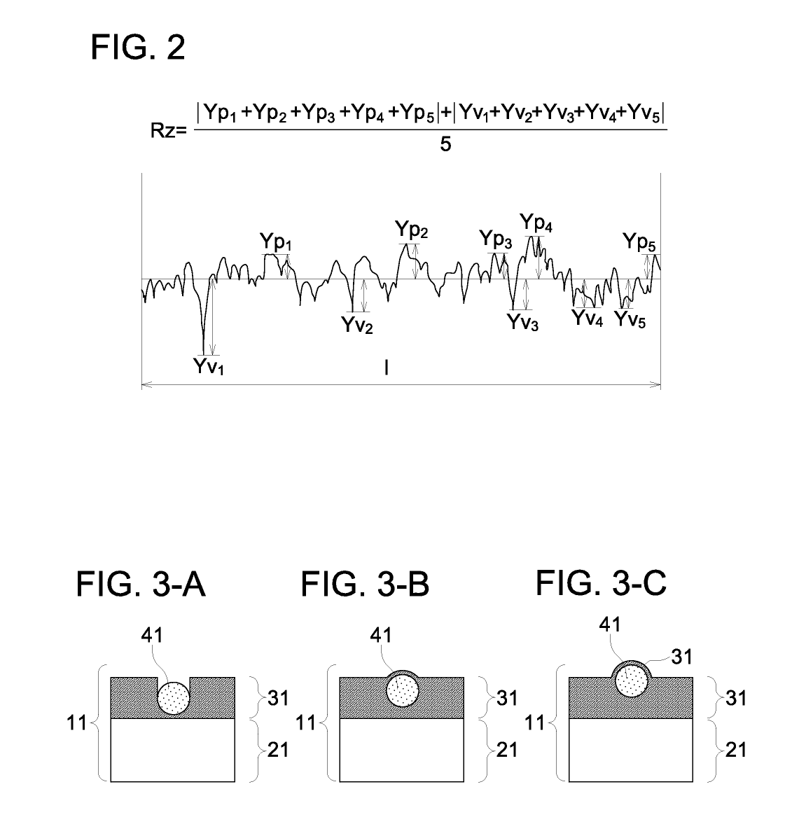

In the present invention, Rz indicates the surface smoothness of the surface of a transparent conductive film. Rz is the value which is obtained by extending the definition of the two-dimensional ten-point average roughness specified by JIS B0601 (1994) as shown in FIG. 2 to three dimensions. Rz is defined as the ten-point average roughness in the portion which is subtracted the standard area S from the specimen surface instead of the standard length 1. That is, the surface roughness (Rz) of the present invention is a value calculated as the sum of the mean value of the absolute value of the height (Yp) from the highest summit to the 5^{th} highest summit, and the mean value of the absolute value of the height (Yv) from the lowest bottom to the 5^{th} lowest bottom. In the present invention, a standard area shall be set as 80 μm×80 μm or more.

In the present invention, a commercially available atomic force microscope (AFM) can be used for measurement of Rz. For example, it can be measured by the following ways.

As an AFM, NanoNavi probe station and S-image high resolution small stage unit (made by Seiko Instruments Co., Ltd.) are used. The sample cut off in a square having a side of about 1 cm is set on a level sample stand on a piezo scanner, then, a cantilever is allowed to approach to a surface of the sample. When the cantilever reaches the region where an atomic force can function, the cantilever is scanned in the XY direction, and irregularity of the surface of the sample is caught by displacement of the piezo element in the Z direction. A piezo scanner which can scan the XY direction of 120 μm and the Z direction of 2 μm is used for the measurement. A cantilever used is silicon cantilever SI-DF20 made by Seiko Instruments Co., Ltd., and measurement is done in a DFM mode (Dynamic Force Mode) using the resonant frequency of 250 to 390 kHz, the spring constant of 42 N/m. The portion of 80×80 μm is measured with the scanning frequency of 0.5 Hz and a ten-point average roughness is obtained. Usually, the ten-point average roughness can be obtained by calculating automatically using analyzing software for measurement data.

In the present invention, the value Rz is in the range of 0<Rz<D (D: average diameter of the conductive fiber). And, it is more preferably in the range of D/8≦Rz<D, and still more preferably, it is in the range of D/4≦Rz<D.

### [Transparent Substrate]

Transparent substrates employed in the present invention are not particularly limited as long as they exhibit high optical transparency. For example, appropriate substrates listed are glass substrates, resin substrates, and resin films in view of excellent hardness and easy formation of a conductive layer on their surfaces. However, in view of low weight and high flexibility, it is preferable to employ the transparent resin films.

Transparent resin films preferably employed in the present invention are not particularly limited, and their materials, shape, structure and thickness may be selected from those known in the art. Examples of the transparent resin films includes: polyester film (e.g., polyethylene terephthalate (PET) film, polyethylene naphthalate film, modified polyester film), polyolefin film (e.g., polyethylene (PE) film, polypropylene (PP) film, polystyrene film, cycloolefin resin film), vinyl resin film (e.g., polyvinyl chloride film, polyvinylidene chloride film), polyether ether ketone (PEEK) film, polysulfone (PSF) film, polyethersulfone (PES) film, polycarbonate (PC) film, polyamide film, polyimide film, acrylic film, and triacetyl cellulose (TAC) film. If the resin films have the transmittance of 80% or more in the visible wavelength (380-780 nm), they are preferably applicable to the transparent resin film of the present invention. It is especially preferable that they are a biaxially-drawn polyethylene terephthalate film, a biaxially-drawn polyethylene naphthalate film, a polyethersulfone film, and a polycarbonate film from a viewpoint of transparency, heat resistance, easy handling, strength and cost. Furthermore, it is more preferable that they are biaxially-drawn polyethylene terephthalate film and a biaxially-drawn polyethylene naphthalate film.

In order to secure the wettability and adhesion property of a coating solution, surface treatment can be performed and an adhesion assisting layer may be provided on the transparent substrate used for the present invention. A well-known technique can be used conventionally with respect to surface treatment or an adhesion assisting layer. Examples of surface treatment include: surface activating treatment such as: corona discharge treatment, flame treatment, ultraviolet treatment, high-frequency wave treatment, glow discharge process, active plasma treatment and laser treatment. Examples of materials for an adhesion assisting layer include: polyester, polyamide, polyurethane, vinyl copolymer, butadiene copolymer, acrylic copolymer, vinylidene copolymer and epoxy copolymer.

When a transparent resin film is a biaxially-drawn polyethylene terephthalate film, it is more preferable to set the refractive index of the adhesion assisting layer which adjoins the transparent resin film to be 1.57 to 1.63 so as to reduce the interface reflection with the film substrate and the adhesion assisting layer and to result in improving transmittance.

Adjusting a refractive index can be achieved by adjusting suitably the relation of the content of tin oxide sol or a cerium oxide sol which has a comparatively high refractive index with respect to the content of the binder resin, and then coating them on the film substrate. Although a single layer may be sufficient as the adhesion assisting, it may be the composition of two or more layers in order to raise adhesion property. Moreover, a barrier coat layer may be beforehand formed in the transparent substrate, and a hard coat layer may be beforehand formed in the opposite side on which a transparent conductive layer is transferred.

### [Transparent Resin]

As a transparent resin used for a transparent electrode of the present invention, there will be no restriction in particular as long as it has a high optical transmittance in the visible region and can function as a binder of a conductive fiber. However, in order to perform a cleaning treatment and a patterning treatment to a transparent conductive film, it is preferable to use a non-aqueous soluble resin which has a water fastness, for example, it can be used a curable resin or a thermoplastic resin.

As a curable resin, a heat curable resin, an ultraviolet curable resin, an electron beam curable can be cited. Among these curable resins, an ultraviolet curable resin is suitably used since the facilities for resin curing is simple and it excels in working property. An ultraviolet curable resin is a resin hardened through a cross linkage reaction by irradiation with UV lights. The ingredient containing the monomer having an ethylenically unsaturated double bond is preferably used.

As a transparent resin concerning the present invention, there can be suitably used, for example, an acrylic urethane resin, a polyester acrylate resin, an epoxy acrylate resin and polyol acrylate resin.

An acrylic urethane resin can be easily obtained by the following ways, in general. Namely, a product is obtained by reacting polyester polyol with an isocyanate monomer or prepolymer, then thus obtained product is reacted with an acrylate monomer having a hydroxyl group such as 2-hydroxyethyl acrylate, 2-hydroxyethyl methacrylate (hereinafter, “an acryrate” includes both “acrylate and methacrylate”) and 2-hydroxypropyl acrylate to obtain an acrylic urethane resin. For example, the compounds described in JP-A No. 59-151110 can be used in the present invention. Specific example preferably used is a mixture of 100 portions of UNIDIC 17-806 (made by DIC Corporation) with 1 portion of CORONATE L (Nippon Polyurethane Industry Co., Ltd.).

As an ultraviolet curable polyester acrylates resin, there are cited compounds which can be easily obtained by allowing to react polyester polyol with a monomer such as 2-hydroxyethyl acrylate or 2-hydroxy acrylate. The compounds described in JP-A No. 59-151112 can be used.

As specific examples of an ultraviolet curable epoxy acrylates resin, there are cited compounds which are prepared using oligomer made by an epoxy acryrate followed by adding a reaction diluent or a photoinitiator to the oligomer. The compounds described in JP-A No. 1-105738 can be used.

As specific examples of an ultraviolet curable polyol acrylates resin, there are cited, for example, trimethylolpropane triacryrate, ditrimethylolpropane tetraacryrate, pentaerythritol triacryrate, pentaerythritol tetraacryrate, dipentaerythritol hexaacryrate and alkyl modified dipentaerythritol pentaacryrate.

As a monomer which has one unsaturated double bond, there can be cited a generally known monomer such as: methyl acryrate, ethyl acrylate, butyl acrylate, benzyl acrylate, cyclohexyl acrylate, vinyl acetate and styrene.

As a monomer which has two or more unsaturated double bond, there can be cited: ethylene glycol diacrylate, propylene glycol diacrylate, divinylbenzne, 1,4-cyclohexane diacrylate, 1,4-cyclohexyldimethyl diacrylate, the above-described trimethylolpropane triaacrylate and pentaerythritol tetraacryrate. Among these, preferably used for a main component of a binder are acrylic active ray curable resins selected from the group consisting of: 1,4-cyclohexane diacrylate, pentaerythritol tetra(meth)acrylate, pentaerythritol tri(meth)acrylate, trimethylolpropane (meth)acrylate, trimethylolethane (meth)acrylate, dipentaerythritol tetra(meth)acrylate, dipentaerythritol penta(meth)acrylate, dipentaerythritol hexa(meth)acrylate, 1,2,3-cyclohexane tetramethacyrate, polyurethane polyacrylate and polyester polyacrylate.

As a photoinitiator used for these ultraviolet curable resins, specifically cited are: benzoin and its derivative, acetophenone, benzophenone, hydroxybenzophenone, Michler's ketone, α-amyloxym ester, thioxanthone and its derivative. These may be used in combination with a photosensitizer. Moreover, sensitizers, such as n-butylamine, triethylamine, and tri-n-butylphosphine, can be used when using a photoinitiator of an epoxy acrylate system. The amount of the photoinitiator or the photosensitizer which is used for an ultraviolet curable resin composition is 0.1 to 15 mass parts to 100 mass parts of the resin composition, and it is preferably 0.1 to 15 weight parts, and it is more preferably 1 to 10 weight parts.

### [Conductive Fiber]

The conductive fiber concerning the present invention has conductivity, and has a form with a length long enough compared with a diameter (thickness). It is thought that the conductive fiber of the present invention forms a two-dimensional conductive network when a conductive fiber contacts each other on a surface of a transparent conductive layer, and it gives conductivity to the surface of the transparent conductive film. Therefore, it is preferable to use a conductive fiber having a longer length since it is advantageous to form a conductive network. On the other hand, when a conductive fiber becomes long, a conductive fiber will become entangled resulting in forming an aggregate, which may deteriorate an optical property.

It is preferable to use the conductive fiber of the optimal average aspect ratio (aspect ratio=length/diameter) according to the conductive fiber to be used, since the rigidity of a conductive fiber, a diameter or other properties may affect the formation of the conductive network and aggregate. As for an average aspect ratio, as a near rough indication, it is preferable to be 10 to 10,000.

As a form of a conductive fiber, there are known several shapes such as a hollow tube, a wire and a fiber. For example, there are an organic fiber coated with metal, an inorganic fiber, a conductive metal oxide fiber, a metal nanowire, a carbon fiber and a carbon nanotube. In the present invention, it is preferable that the thickness of a conductive fiber is 300 nm or less from a viewpoint of transparency. In addition, in order to also satisfy conductivity of a conductive fiber, it is preferable that the used conductive fiber is at least one selected from the group consisting of a metal nanowire and a carbon nanotube. Furthermore, a silver nanowire can be most preferably used from a viewpoint of cost (a material cost, a cost of production) and properties (electro-conductivity, transparency and flexibility).

The diameter of a conductive fiber as used in the present invention means the diameter of a projection in a right-angled direction to the length direction of a conductive fiber, and the average diameter of a conductive fiber means the arithmetic mean value of the diameter of each conductive fiber. Although the length of conductive fibers should be principally measured in the state where they are extended to straight shape. In reality, in most cases, they are curved. Consequently, by employing electron microscopic images, the projected diameter and projected area of each of the nanowires were calculated employing an image analysis apparatus and the length of each conductive fiber is obtained (length=projected area/projected diameter).

In the present invention, it is possible to determine the above describe average values of diameter, length and aspect ratio of the conductive fibers as follows. A sufficient number of electron microscopic images of the conductive fibers in the state of dispersed are taken. Subsequently, each of the conductive fiber images is measured and the arithmetic average is obtained. In the present invention, a relative standard deviation of length or diameter is represented with a value obtained from the standard deviation value of the measured values divided by the average value of the measured values, which is multiplied by 100.

Relative standard deviation (%)=(Standard deviation value of the measured values/average value of the measured values)×100

The sample number of the conductive fibers to be measured for obtaining an average value or a relative standard deviation is preferably at least 300, and it is more preferably at least 500.

### [Metal Nanowires]

Generally, metal nanowires indicate a linear structure composed of a metallic element as a main structural element. In particular, the metal nanowires in the present invention indicate a linear structure having a diameter of from an atomic scale to a nanometer (nm) size.

In order to form a long conductive path by one metal nanowire, a metal nanowire applied to the conductive fibers concerning the present invention is preferably have an average length of 3 μm or more, more preferably it is 3 to 500 μM, and still more it is 3 to 300 μm. In addition, the relative standard deviation of the length of the conductive fibers is preferably 40% or less. Moreover, from a viewpoint of transparency, a smaller average diameter is preferable, on the other hand, a larger average diameter is preferable from a conductive viewpoint. In the present invention, 10 to 300 nm is preferable as an average diameter of metal nanowires, and it is more preferable to be 30 to 200 nm. Further, the relative standard deviation of the diameter is preferably to be 20% or less.

There is no restriction in particular to the metal composition of the metal nanowire of the present invention, and it can be composed of one sort or two or more metals of noble metal elements or base metal elements. It is preferable that it contains at least one sort of metal selected from the group consisting of noble metals (for example, gold, platinum, silver, palladium, rhodium, iridium, ruthenium and osmium), iron, cobalt, copper and tin. It is more preferable that silver is included in it at least from a conductive viewpoint. Moreover, for the purpose of achieving compatibility of conductivity and stability (sulfuration resistance and oxidation resistance of metal nanowire and migration resistance of metal nanowire), it is also preferable that it contains silver and at least one sort of metal belonging to the noble metal except silver. When the metal nanowire of the present invention contains two or more kinds of metallic elements, metal composition may be different between the surface and the inside of metal nanowire, and the whole metal nanowire may have the same metal composition.

In the present invention, there is no restriction in particular to the production means of metal nanowires. It is possible to prepare metal nanowires via various methods such as a liquid phase method or a gas phase method. For example, the manufacturing method of Ag nanowires may be referred to Adv. Mater. 2002, 14, 833-837 and Chem. Mater. 2002, 14, 4736-4745; a manufacturing method of Au nanowires may be referred to JP-A No. 2006-233252; the manufacturing method of Cu nanowires may be referred to JP-A No. 2002-266007; while the manufacturing method of Co nanowires may be referred to JP-A No. 2004-149871. Specifically, the manufacturing methods of Ag nanowires, described in Adv. Mater. 2002, 14, 833-837 and Chem. Mater. 2002, 14, 4736-4745, may be preferably employed as a manufacturing method of the metal nanowires according to the present invention, since via those methods, it is possible to simply prepare a large amount of Ag nanowires in an aqueous system and the electrical conductivity of silver is highest of all metals.

### [Production Method]

In the production method of the transparent conductive film of the present invention, there is no restriction in particular to the methods. However, it is preferable to use the following method. The method contains: to form a conductive fiber layer containing a conductive fiber and a soluble binder on a mold-releasing surface of a mold-releasing substrate; then to transfer the conductive fiber layer onto a transparent substrate by using a transparent resin as an adhesive agent to result in forming a transparent conductive film; then to remove at least a part of the soluble binder from the surface of the formed transparent conductive film to result in forming the targeted transparent conductive film.

As a mold-releasing substrate used in the production method of the transparent electrode of the present invention, a resin substrate and a resin film are cited suitably. There is no restriction in particular to this resin, and it can be chosen suitably from the known compounds. The substrate and film containing a single layer or a multiple layers made of synthetic resin are used suitably. Example of the resins are: a polyethylene terephthalate resin, a vinyl chloride resin, an acrylic resin, a polycarbonate resin, a polyimide resin, a polyethylene resin and polypropylene resin. In addition, a glass substrate and a metal substrate can also be used. Surface lubricants, such as a silicone resin, a fluororesin, and wax, may be applied to the surface (mold-releasing surface) of a mold-releasing substrate, and a surface treatment may be performed to it when needed.

Since the surface of the mold-releasing substrate affects the surface smoothness of the surface of a transparent conductive film which is formed by transferring the conductive fiber layer, it is preferable that the surface of the mold-releasing substrate is highly smooth. Specifically, the surface of the mold-releasing substrate has preferably a maximum height (Ry) of Ry<50 nm, it is more preferably Ry<40 nm, and it is still more preferably Ry<30 nm. Moreover, it is preferable that the arithmetic mean roughness (Ra) is Ra<5 nm, it is more preferable to be Ra<3 nm, and it is still more preferable to be Ra<1 nm.

In the present invention, Ra and Ra show the surface smoothness of the surface of a transparent conductive layer. Ry means a maximum height (vertical interval of a surface summit part and a bottom part), and Ra means an arithmetic mean roughness, and they are a value according to the surface roughness specified in JIS B601 (1994). In measurement of Ry and Ra, they can be measured using a commercial atomic force microscope (Atomic Force Microscope: AFM), for example, NanoNavi probe station and S-image high resolution small stage unit (made by Seiko Instruments Co., Ltd.).

In the production method of forming a conductive fiber layer containing a conductive fiber and a soluble binder on a mold-releasing surface of a mold-releasing substrate, there is no restriction in particular to the methods. However, in view of productivity, improvement in quality, as well as reduction of environmental load, it is preferable to employ liquid phase film forming methods such as coating methods or printing methods for forming a conductive fiber layer. As a coating method employed may be a roller coating method, a bar coating method, a dip coating method, a spin coating method, a casting method, a die coating method, a blade coating method, a bar coating method, a gravure coating method, a curtain coating method, a spray coating method, and a doctor coating method. As a printing method employed may be a letterpress (typographic) printing method, a porous (screen) printing method, a lithographic (offset) printing method, an intaglio (gravure) printing, a spray printing method, and an ink jet printing method. As preliminary treatment to enhance close contact and coatability, if desired, the surface of a mold-releasing substrate may be subjected to physical surface treatment such as corona discharge treatment or plasma discharge treatment.

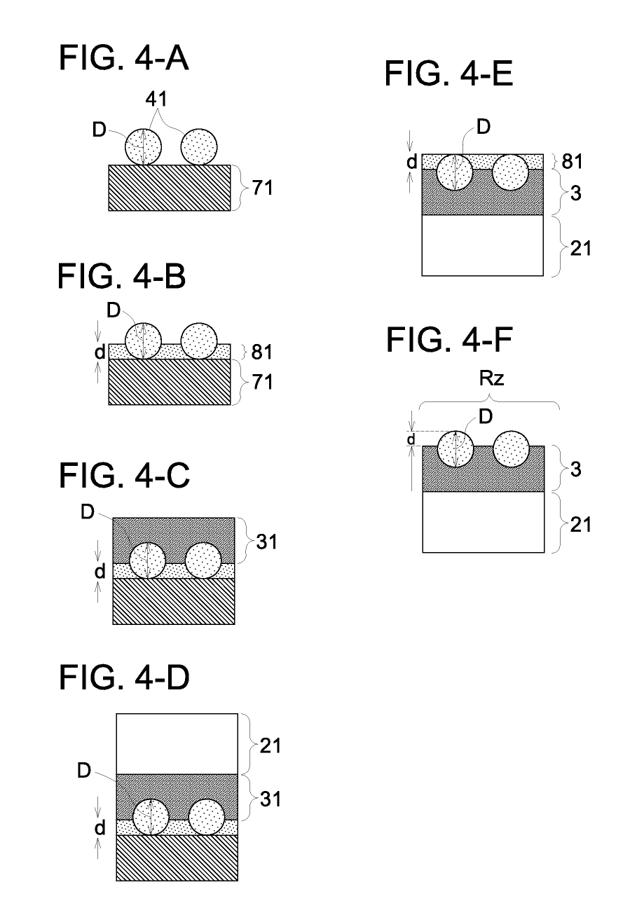

As a specific production method of the transparent conductive film of the present invention, a process as shown, for example, in FIG. 4 can be cited. On the mold-releasing surface of mold-releasing substrate 71, the dispersion liquid of conductive fiber 41 (the figure represents the section of a conductive fiber) is applied (or is printed), followed by drying, and the conductive network structure composed of conductive fibers which spread at random in two dimensions chiefly on the mold-releasing surface of mold-releasing substrate is formed (FIG. 4 (4-A)). Subsequently, a soluble binder solution is applied on the network structure of the conductive fibers (or is printed) to make penetrated the transparent conductive material between the space of the network of the conductive fibers. Then it is dried to form a transparent conductive layer incorporating film 81 (having the thickness of d) containing the transparent conductive fibers and a soluble binder (FIG. 4 (4-B)). Subsequently, an adhesive agent layer (transparent resin layer 31) is applied on the conductive fiber layer, and it is stuck with another transparent substrate 21 (FIG. 4 (4-C) and (4-D)). After curing the adhesive agent layer, by peeling off the mold-releasing substrate 71, the conductive fiber layer is transferred to the transparent substrate, and a transparent conductive film is produced (FIG. 4 (4-E)). Then, the soluble binder on the surface of the transparent conductive film is removed using a suitable solvent, and a conductive fiber is exposed on the surface of the transparent conductive film (FIG. 4 (4-F)).

According to this process, since a conductive fiber can be made to exist exclusively on a surface of a transparent conductive film, it ca form the transparent conductive film excellent in surface conductivity. Moreover, since the surface of the transparent conductive film after transfer becomes a form reflecting the surface smoothness of the mold-releasing substrate surface, it can improve the surface smoothness of the transparent conductive film in the state of FIG. 4 (4-E) by using the mold-releasing substrate excellent in surface smoothness. Furthermore, the exposure amount (equivalent to d) of the conductive fiber on the surface of the transparent conductive film in the state of FIG. 4 (4-F) is uniformly controllable by choosing suitably thickness d of the film formed with the soluble binder in a conductive fiber layer. As a result, it becomes possible to produce easily a transparent conductive film of the present invention so that the surface roughness (Rz) of the transparent conductive film will satisfy the relationship of 0<Rz<D with respect to the average diameter (D) of a conductive fiber.

In the production method of the transparent conductive film of the present invention as described above, a soluble binder can be mixed with the dispersion liquid of a conductive fiber, and it can also be applied together (or printed). When the thickness (d) of the film formed with a soluble binder is larger than the average diameter (D) of the conductive fiber, the conductive fiber may also be removed together in the removal process of the soluble binder. Therefore, the relationship between the thickness of the film formed with a soluble binder and the average diameter of the conductive fiber is preferably to be: 0<d<D. Further, in order to secure the hold ability of the conductive fiber by the transparent resin, it is more preferable that the relationship will satisfy 0<d≦(⅞)D, and it is especially preferable that the relationship will satisfy 0<d≦(¾)D. Moreover, in the removal process of a soluble binder, in order to remove a soluble binder efficiently, energy, such as a pressure and an ultrasound, can also be added in the extent which does not affect the holding ability of the conductive fiber by the transparent resin.

In the production method of the transparent conductive film of the present invention, although there is no restriction in particular to a soluble binder to be used, it is preferable that the solvent of a soluble binder does not affect the holding ability of the conductive fiber by the transparent resin. Furthermore, it is preferable to use a water soluble binder from the viewpoint of environmental aptitude or safety.

As a water soluble binder which can be preferably used in the present invention, although a synthetic water soluble polymer and a natural water soluble polymer are cited, for example, both can be used preferably.

Among these, as a synthetic water solubility polymer, it can be cited, for example, a compound having a nonionic group in the molecule, a compound having an anionic group in the molecule and a compound having an anionic group into molecular structure. Examples of a nonionic group are, for example, an ether group, an ethyleneoxide group and a hydroxy group. Examples of an anionic group are, for example, a sulfonic acid group and its salt, a carboxylic acid group and its salt, and a phosphate group and its salt.

These synthetic water solubility polymers may be a homopolymer or a copolymer composed of on one or more kinds of monomers. Further, this copolymer may be a copolymer composed of partially a hydrophobic monomer, as long as the homopolymer exhibits water solubility. However, it is necessary to be contained in the range which does not produce a side effect when the copolymer is added for use.

As a natural water soluble polymer also, it can be cited a compound having a nonionic group in the molecule, a compound having an anionic group in the molecule and a compound having an anionic group into molecular structure.

In the present invention, a water soluble polymer is required to be soluble in an amount of 0.05 g or more to 100 g of water at 20° C., preferably it is required to be soluble in an amount of 0.1 g or more. The molecular weight thereof is preferably from 1,000 to 40,000, more preferably, it is not more than 20,000, and still more preferably, it is not more than 10,000.

As a synthetic water soluble polymer, it can be cited a polymer containing the repeating unit represented by Formula (P) in an amount of 10 to 100 mol % in one molecule of polymer.

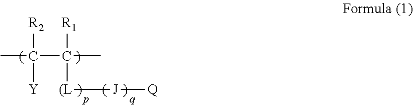

In Formula, R₁ and R₂ may be the same or different, and each represent a hydrogen atom or an alkyl group, preferably represent an alkyl group with 1-4 carbon atoms (including an alkyl group having a substituent). For example, they represent a methyl group, an ethyl group, a propyl group or a butyl group; L represents —CONH—, —NHCO—, —COO—, —COO—, —CO—, —SO₂—, —NHSO₂—, —SO₂NH— or —O—; J represents an alkylene group, preferably an alkylene group of 1-10 carbon atoms (including an alkylene group having a substituent). Examples of an alkylene group include: a methylene group, an ethylene group, a propylene group, a trimethylene group, a butylene group and a hexylene group; an arylene group (including an arylene group having a substituent) such as a phenyl group; an aralkylene group (including an aralkylene group having a substituent) such as —CH₂—C₆H₄—; —(CH₂CH₂O)ₙ—(CH₂)ₙ—, or —(CH₂CH(OH)CH₂O)-α-(CH₂)ₙ—, (hereon represents an integer of 0 to 4, and n represents an integer of 0 to 4).

Q represents:

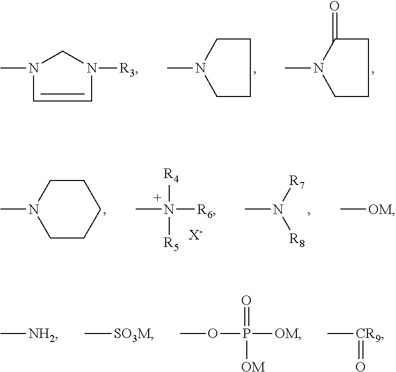

Q further represents a hydrogen atom or R₃.

M represents a hydrogen atom or a cationic group. R₉ represents an alkyl group with 1-4 carbon atoms (for example, a methyl group, an ethyl group, a propyl group or a butyl group). R₃, R₄, R₅, R₆, R₇ and R₈ each represents a hydrogen atom; an alkyl group with 1-4 carbon atoms (for example, a methyl group, an ethyl group, a propyl group, a butyl group, a hexyl group, a decyl group or a hexadecyl group); a phenyl group (for example, a phenyl group, a methoxyphenyl group or a chlorophenyl group); and an aralkyl group (for example, a benzyl group). X represents an anion group, p and q each represents an integer of 0 or 1. It is especially preferable to use a polymer containing an acryl amido or a mathacryl amido group.

Y represents a hydrogen atom or -(L)ₚ-(J)_{q}-Q.

The synthetic water soluble polymer used in the present invention can be copolymerized with an ethylenically unsaturated monomer. Examples of an ethylenically unsaturated monomer which can be copolymerized are: styrene, alkyl styrene, hydroxyalkyl styrene (an alkyl group of 1 to 4 carbon atoms, for example, methyl, ethyl and butyl), vinylbenzene sulfonic acid or its salt, α-methyl styrene, 4-vinylpyridine, N-vinyl pyrrolidone, mono-ethylenic unsaturated ester of fatty acid (for example, vinyl acetate and vinyl propionate), ethylenic unsaturated monocarboxylic acid or dicarboxylic acid, and their salts (for example, acrylic acid and methacrylic acid), maleic anhydride, ester of ethylenic unsaturated monocarboxylic acid or dicarboxylic acid (for example, n-butyl acryrate, an N,N-diethylaminoethyl methacyrate and N,N-diethylaminoethyl methacyrate), amide of ethylenic unsaturated monocarboxylic acid or dicarboxylic acid (for example, acrylamide, 2-acrylamide-2-methylpropanesulfonic acid soda and N,N-dimethyl-N′-methacryloyl propane diamine acetate betaine).

Specific examples of a synthetic water soluble polymer of Formula (P) are shown in the following.

| | | Number average molecular weight Mn |
|---|---|---|
| P-1 | 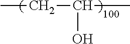 | 8,000 |
| P-2 | 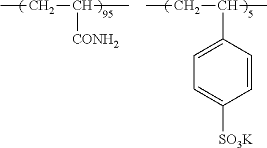 | 15,000 |
| P-3 | 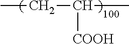 | 4,800 |
| P-4 | 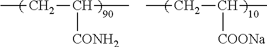 | 9,000 |
| P-5 | 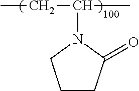 | 3,100 |
| P-6 | 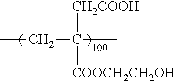 | 11,000 |
| P-7 | 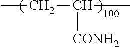 | 3,000 |
| P-8 | 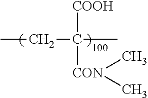 | 8,000 |
| P-9 | 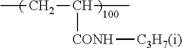 | 6,000 |
| P-10 | 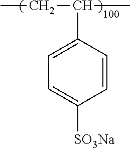 | 7,800 |
| P-11 | 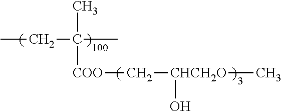 | 10,000 |
| P-12 | 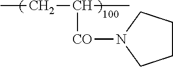 | 9,500 |
| P-13 | 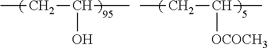 | 9,000 |
| P-14 | 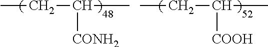 | 12,000 |
| P-15 | 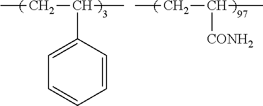 | 5,300 |
| P-16 | 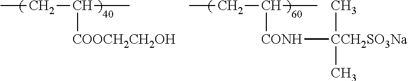 | 8,000 |
| P-17 | 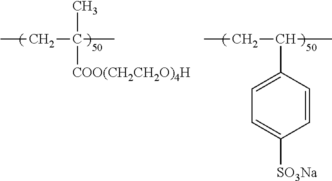 | 9,000 |
| P-18 | 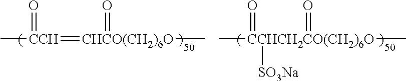 | 10,000 |
| P-19 | 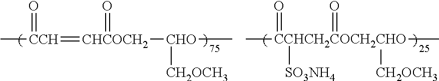 | 20,000 |
| P-20 | 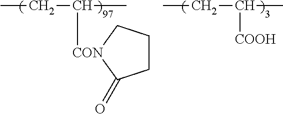 | 8,000 |
| P-21 | 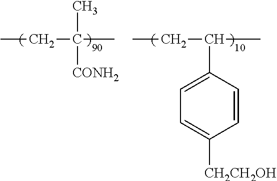 | 11,000 |
| P-22 | 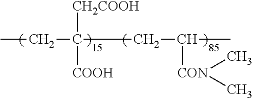 | 9,000 |
| P-23 | 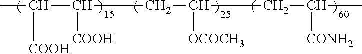 | 11,500 |
| P-24 | 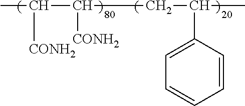 | 8,500 |

A water soluble polyester can be cited as another example of a synthetic water soluble polymer.

As a water soluble polyester, it can be cited a soluble polyester obtained, for example, by polycondensation reaction of a mixed dicarboxylic acid component and a glycol component.

In order to give water solubility, it is preferable to contain a dicarboxylic acid component containing a sulfonic acid salt as a dicarboxylic acid (a dicarboxylic acid containing a sulfonic acid salt and/or its ester derivative).

As a dicarboxylic acid containing a sulfonic acid salt and/or its ester derivative, preferable is a compound containing sulfonic acid alkali metal salt. Examples thereof are, an alkali metal salt or an ester derivative of: 4-sulfoisophthalic acid, 5-sulfoisophthalic acid, sulfoterephthalic acid, 4-sulfophthalic acid, 4-sulfonaphthalene-2,7-dicarboxylic acid and 5-[4-sulfophenoxy]isophthalic acid. Among these, especially preferable is a sodium salt or an ester derivative of 5-sulfoisophthalic acid. These dicarboxylic acids containing a sulfonic acid salt and/or its ester derivative are preferably contained in an amount of 5 mol % or more with respect to the total amount of the dicarboxylic acid in order to give sufficient water solubility.

The following compounds are cited as the above-mentioned dicarboxylic acid components for example: an aromatic dicarboxylic acid component (an aromatic dicarboxylic acid and/or its ester derivative); an alicyclic dicarboxylic acid component (an alicyclic dicarboxylic acid and/or its ester derivative); and an aliphatic dicarboxylic acid component (an aliphatic dicarboxylic acid and/or its ester derivative).

As an aromatic dicarboxylic acid component, there can be mainly cited for example: a terephthalic acid component (terephthalic acid and/or its ester derivative); and an isophthalic acid component (isophthalic acid and/or its ester derivative).

Specific examples of an aromatic dicarboxylic acid component are cited as: aromatic dicarboxylic acids such as phthalic acid, 2,5-dimethylterephthalic acid, 2,6-naphthalene dicarboxylic acid, 1,4-naphthalene dicarboxylic acid, biphenyl dicarboxylic acid, and their ester derivatives.

As an alicyclic dicarboxylic acid and/or its ester derivative, there can be used for example: 1,4-cyclohexanedicarboxylic acid, 1,3-cyclohexanedicarboxylic acid, 1,2-cyclohexanedicarboxylic acid, 1,3-cyclopentane dicarboxylic acid, 4,4′-bicyclohexyldicarboxylic acid and their ester derivatives.

It may be used a straight chain aliphatic dicarboxylic acid and/or its ester derivative in the range of 15 mol % or less with respect to the total dicarboxylic acid component. Examples of such straight chain aliphatic dicarboxylic acid are: adipic acid, pimelic acid, suberic acid, azelaic acid and sebacic acid. Their ester derivatives are also usable.

It is preferable to use ethylene glycol in an amount of 50 mol % or more with respect to the total glycol component from the viewpoint of mechanical property and adhesion property of the polyester copolymer. As a glycol component used for the present invention, it may be used, in addition to ethylene glycol: 1,4-butanediol, neopentyl glycol, 1,4-cyclohexanedimethanol, diethylene glycol, triethylene glycol and polyethylene glycols. Moreover, in order to give water solubility, polyethylene glycols can be preferably used together.

Examples of a natural water soluble polymer are described in detail in the collection of comprehensive technical data of water soluble polymer resins dispersed in (made by Administration Development Center publication division). Preferable examples thereof are: lignin, starch, pullulan, cellulose, alginic acid, dextran, dextrin, guar gum, gum arabic, pectin, casein, agar, xanthan gum, cyclodextrin, locust bean gum, tragant gum, carrageenan, glycogen, laminaran, lichenin, nigeran and their derivatives.

Preferable derivatives of a natural water soluble polymer are compounds produced by sulfonation, carboxylation, phosphorylation, making sulfoalkylene, making carboxy alkylene, making alkyl phosphoric acid and their salts, making polyoxyalkylene (for example, ethylene, glycerine and propylene), and alkylation (for example, methylation, ethylation and benzylation).

Among natural water soluble polymers, glucose polymers and their derivatives are desirable. In glucose polymers and their derivatives, preferable compounds are: starch, glycogen, cellulose, lichenin, dextran, dextrin, cyclodextrin, nigeran. Especially preferable compounds are: cellulose, dextrin, cyclodextrin, and their derivatives.

Examples of cellulose derivatives are: carboxymethyl cellulose, methyl cellulose, hydroxypropyl methylcellulose and hydroxyethylmethyl cellulose.

In the above-mentioned process, it is effective as a way of raising the conductivity of the network structure of a conductive fiber to perform a calendar process and heat treatment and to improve the adhesion between conductive fibers after applying and drying a conductive fiber, or to perform plasma treatment and to reduce the contact resistance between conductive fibers. Moreover, in the above-mentioned process, the mold-releasing surface of the mold-releasing substrate may be subjected to hydrophilization treatment by corona discharge (plasma) beforehand.

In the above-mentioned process, an adhesive agent layer may be prepared on the conductive fiber layer side, as shown in FIG. 4 (4-C), and it may be prepared on the transparent substrate side which is stuck together. Moreover, an adhesive agent layer may be used as a transparent resin layer which holds a conductive fiber like the above-mentioned process, or it may be possible to stick and transfer the transparent resin layer 32 as an adhesive agent layer after forming the transparent resin layer 31 on the conductive fiber layer like the transparent conductive film structure shown in FIG. 1 (1-B).

There is no limitation in particular to the adhesive agent used for the adhesive agent layer as long as it is a material transparent in the visible region and has a transferring ability. It can be selected from the compounds listed in the description of the above-mentioned transparent resin and can be used.

Although there is no limitation in particular to the methods of sticking and adhesion in the above-mentioned process, a sheet press and a roll press can be applied. It is preferable to carry out sticking and adhesion using a roll press machine. A roll press is the way of holding the film to be adhered by pressure between rolls, and rotating the rolls. A roll press can give pressure uniformly and the manufacturing efficiency is higher than a sheet press, it can be used more suitably.

In the process which removes the soluble binder on the surface of a transparent conductive film by rinsing treatment to expose the conductive fiber on the surface of a transparent conductive film, the soluble binder may be remained without completely removed as the transparent conductive film structure illustrated in FIG. 1-C, and a part of soluble binder film (layer) may remain as a transparent resin layer 33 on the surface of the transparent resin layer 31.

### [Patterning Method]

The transparent conductive film concerning the present invention can be used after patterned. There is no restriction in particular to the method and process of patterning, and a well-known approach can be applied suitably. For example, after forming the patterned transparent conductive fiber layer on the surface of the mold-releasing substrate, a patterned transparent conductive film can be formed by transferring onto a transparent substrate. A patterned transparent conductive film can also be formed after producing the transparent conductive film of the present invention by patterning.

As a specific method for forming a patterned transparent conductive fiber layer on a surface of a mold-releasing substrate, the following methods can be used, for example.

(1) The method in which a transparent conductive fiber layer of the present invention is directly built in a pattern by using a printing method on a mold-releasing substrate.
(2) The method in which a transparent conductive fiber layer of the present invention is uniformly built on a mold-releasing substrate followed by carrying out pattering by a conventional photolithographic process using an etching liquid for the transparent conductive fiber.
(3) The method in which a transparent conductive fiber layer of the present invention is uniformly built in a negative pattern using a photoresist which has been provided on a mold-releasing substrate, then patterning using a lift off method is carried out.

As a specific method for performing patterning after producing a transparent conductive fiber layer, the following methods can be used, for example.

(4) The method in which a transparent conductive fiber layer of the present invention is built, then, patterning is performed using a printing method by applying an etching liquid for the conductive fiber in a negative patter.
(5) The method in which a transparent conductive fiber layer of the present invention is built, then, patterning is performed using a conventional photolithographic method by using an etching liquid for the conductive fiber.

### [Appropriate Application]

The transparent electrode of the present invention has high conductivity and transparency, and it can be used conveniently in the field of various optoelectronic devices such as liquid crystal display elements, organic electroluminescence elements, inorganic electroluminescence elements, electronic papers, organic solar cells, and inorganic solar cells; electromagnetic wave shields and touch panels. Among them, it can be suitably used for an organic electroluminescence element which is severely required the surface smoothness of the surface of a transparent electrode or for a transparent electrode of an organic thin film solar battery element.

### EXAMPLES

The present invention is described below with reference to examples, but the present invention is not limited to these.

### (Conductive Fibers)

In the present example, silver nanowires are used as conductive fibers. There were prepared silver nanowires having an average diameter of 50 nm and an average length of 32 μm with reference to the method described in Adv. Mater., 2002, 14, 833-837, and WO 2008/073143 A2. The prepared silver nanowires were filtered using an ultrafiltration membrane followed by washing with water. Then re-dispersed in ethanol to obtain a dispersion of silver nanowires (content of silver nanowires being 5 mass %). In any examples, the application of a dispersion of silver nanowires was done using a spin coater.

### Example 1

### Preparation of Transparent Conductive Film

Preparation of Transparent conductive film TC-1A

A transparent electrode was produced according to the preferable manufacturing process of the transparent conductive film of the present invention shown in the above-mentioned FIG. 4. As a mold-releasing substrate, it was used a PET film having a clear hard coat layer (CHC) as a mold releasing surface, having the surface smoothness of Rz=9 nm and Ra=1 nm.

(1) After applying a silver nanowire dispersion liquid to the mold-releasing substrate which had been performed corona discharge treatment so that the coverage of silver nanowire may be set to 60 mg/m², the dry process was carried out at 120° C. for 30 minutes, and a silver nanowire network structure was formed.
(2) Subsequently, an aqueous solution of polyvinyl alcohol (PVA) as a soluble binder overcoat was overcoated to the above-mentioned silver nanowire network structure so that the dried thickness might be set to 5 nm. In addition, the coating thickness of the film formed with a soluble binder is the value measured by the following way.

From the sample coated with the soluble binder, a cross-sectional cut piece vertical to the substrate was produced using a microtome, then a transmission electron microscope picture of this cross-sectional cut piece was taken, and this picture image was measured to obtain the thickness of the membrane formed with the soluble binder.

(3) After applying an ultraviolet curing type transparent resin (the product made by JSR, NN803) to form an adhesive layer (corresponding to a dried thickness of 1.5 μm), and evaporating a solvent ingredient, it was stuck with a PET film (the total optical transmittance of 90%) as a transparent substrate which has a barrier layer and an adhesive layer.
(4) Then, after irradiating with UV lights to fully cure the adhesive layer, by peeling the mold-releasing substrate, the conductive fiber layer was transferred to the transparent substrate, and further, the soluble binder PVA was washed out with water to prepare transparent conductive film TC-1A.

### Preparation of Transparent Conductive Film TC-1B

Transparent conductive film TC-1B was prepared in the same manner as preparation of transparent conductive film TC-1A, except that the dried thickness of the soluble binder in the process (2) was changed to be 10 nm.

### Preparation of Transparent Conductive Film TC-1C

Transparent conductive film TC-1C was prepared in the same manner as preparation of transparent conductive film TC-1A, except that the dried thickness of the soluble binder in the process (2) was changed to be 20 nm.

### Preparation of Transparent Conductive Film TC-1D

Transparent conductive film TC-1D was prepared in the same manner as preparation of transparent conductive film TC-1A, except that the dried thickness of the soluble binder in the process (2) was changed to be 30 nm.

### Preparation of Transparent Conductive Film TC-1E

Transparent conductive film TC-1E was prepared in the same mariner as preparation of transparent conductive film TC-1A, except that the dried thickness of the soluble binder in the process (2) was changed to be 40 nm.

### Preparation of Transparent Conductive Film TC-1F

Transparent conductive film TC-1F was prepared in the same manner as preparation of transparent conductive film TC-1A, except that the dried thickness of the soluble binder in the process (2) was changed to be 45 nm.

### Preparation of Transparent Conductive Film TC-1G

Transparent conductive film TC-1G was prepared in the same manner as preparation of transparent conductive film TC-1A, except that the dried thickness of the soluble binder in the process (2) was changed to be 50 nm.

### Preparation of Transparent Conductive Film TC-1H

Transparent conductive film TC-1H was prepared in the same manner as preparation of transparent conductive film TC-1A, except that the dried thickness of the soluble binder in the process (2) was changed to be 100 mm.

### Preparation of Transparent Conductive Film TC-1I

In accordance with the conventional method, a transparent conductive film using a conductive fiber was produced by the following way. As a mold-releasing substrate, it was used a PET film having a clear hard coat layer (CHC) as a mold releasing surface, having the surface smoothness of Rz=9 nm and Ra=1 nm.

(5) After applying a silver nanowire dispersion liquid to the mold-releasing substrate which had been performed corona discharge treatment so that the coverage of silver nanowire may be set to 60 mg/m², the dry process was carried out at 120° C. for 30 minutes, and a silver nanowire network structure was formed.
(6) After applying an ultraviolet curing type transparent resin (made by JSR, NN803) on the above-described silver wire network structure to form an adhesive layer (corresponding to a dried thickness of 1.5 μm), and evaporating a solvent ingredient, it was stuck with a PET film (total optical transmittance: 90%) as a transparent substrate which has a barrier layer and an adhesion assistant layer.
(7) Then, after irradiating with UV lights to fully cure the adhesive layer, by peeling the mold-releasing substrate, the conductive fiber layer was transferred to the transparent substrate to obtain transparent conductive film TC-1I.

### Preparation of Transparent Conductive Film TC-1J

In accordance with the conventional method, a transparent conductive film using a conductive fiber was produced by the following way. It was used a PET film (total optical transmittance: 90%) as a transparent substrate which has a barrier layer and an adhesive layer.

(8) After applying a silver nanowire dispersion liquid to the transparent substrate which had been performed corona discharge treatment so that the coverage of silver nanowire may be set to 60 mg/m², the dry process was carried out at 120° C. for 30 minutes, and a silver nanowire network structure was formed.
(9) Further, after applying an ultraviolet curing type transparent resin (made by JSR, NN803) as a transparent resin on the above-described silver nanowire network structure so the dried thickness became to be 25 nm, and evaporating the solvent ingredient, it was irradiated with UV lights to fully cure the adhesive layer to obtain Transparent conductive film TC-1J.

### Preparation of Transparent Conductive Film TC-1K

Transparent conductive film TC-1K was prepared in the same manner as preparation of transparent conductive film TC-1J, except that the dried thickness of the transparent resin in the process (9) was changed to be 50 nm.

### Preparation of Transparent Conductive Film TC-1L

Transparent conductive film TC-1L was prepared in the same manner as preparation of transparent conductive film TC-1J, except that the dried thickness of the transparent resin in the process (9) was changed to be 100 nm.

### Preparation of Transparent Conductive Film TC-1M

Transparent conductive film TC-1M was prepared in the same manner as preparation of transparent conductive film TC-1J, except that the dried thickness of the transparent resin in the process (9) was changed to be 200 nm.

### Example 2

### Evaluation of Transparent Conductive Film

### (Evaluation of Exposure of Conductive Fibers)

Etching treatment was carried out to the transparent conductive films TC-1A to TC-1M prepared in Examples 1. Exposure of conductive fibers was evaluated by measuring the change of the surface resistivity before and after the etching treatment. The etching treatment was performed by immersing each transparent conductive film in an etching solution having the following composition for 1 minute. Each transparent conductive film after being carried out the etching treatment was subjected to washing treatment with running water, then it was fully dried.

### (Etching Solution)

| | |
|---|---|
| Ethylenediaminetetraacetic acid iron (III) ammonium salt | 60 g |
| Ethylenediaminetetraacetic acid | 2 g |
| Sodium metabisulfite | 15 g |
| Ammonium thiosulfate | 70 g |
| Maleic acid | 5 g |

Adding pure water to become 1 L, and then adjusted to pH 5.5 with sulfuric acid, or an aqueous ammonia solution.

When surface resistivity before an etching process is set to be Rb and surface resistivity after an etching process is set to be Ra, the change (Ra/Rb) of the surface resistivity of each sample before and after the etching process order is classified as follows, and the results are shown in Table 1. “D” indicates that the sample does not satisfy the requirement of the present invention with respect to the exposure. “A” to “C” each indicates that the sample satisfies the requirement of the present invention. “B” indicates that the sample exhibits more preferable state in the present invention. “A” indicates that the sample exhibits still more preferable state.

D: Ra/Rb<10²

C: 10²≦Ra/Rb≦10⁴

B: 10⁴≦Ra/Rb≦10⁶

A: 10⁶≦Ra/Rb

### (Evaluation of Surface Roughness of Transparent Conductive Film)

Surface roughness (Rz) of transparent conductive films TC-1A to TC-1M prepared in Examples 1 was evaluated using the method with AFM as describe above. The relationships between the obtained Rz values and the average diameter (D=50 nm) of the employed silver nanowires were classified as follows, and the results are shown in Table 1. “D” indicates that the sample does not satisfy the requirement of the present invention with respect to the surface roughness. “A” to “C” each indicates that the sample satisfies the requirement of the present invention. “B” indicates that the sample exhibits more preferable state in the present invention. “A” indicates that the sample exhibits still more preferable state.

D: Rz≧D

C: 0≦Rz≦D/8

B: D/8≦Rz<D/4

A: D/4≦Rz<D

### (Functional Evaluation as Transparent Electrode)

Organic EL elements EL-1A to EL-1M each were respectively produced in the following processes by using transparent conductive film TC-1A to TC-1M produced in Example 1 as an anode electrode

### <Formation of Positive Hole Transporting Layer>

The coating solution for a positive hole transporting layer was prepared by dissolving 4,4′-bis[(N-(1-naphthyl)-N-phenylamino)]biphenyl (NPD) in 1,2-dichloroethane so that the content of NPD became 1 weight %. This coating solution was coated on the anode with a spin coating apparatus followed by drying at 80° C. for 60 minutes to form a positive hole transporting layer having a thickness of 40 nm.

### <Formation of Light Emission Layer>

The coating solution for forming light emission layer was prepared by dissolving polyvinyl carbazole (PVK) as a host material, 1 weight % of a red dopant material Btp₂Ir(acac), 2 weight % of a green dopant material Ir(ppy)₃ and 3 weight % of a blue dopant material FIr(pic) (the indicated weight % was based on the weight of PVK) in 1,2-dichloroethane so that the total solids content of PVK and the three dopants became 1 weight %. This coating solution was coated with a spin coating apparatus followed by drying at 100° C. for 10 minutes to form a light emission layer having a thickness of 60 mm

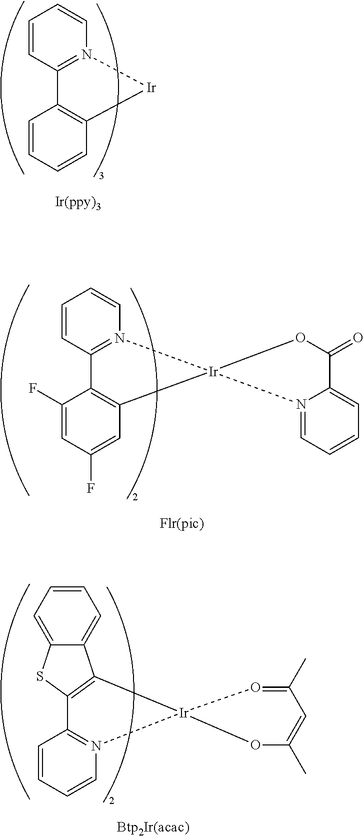

### <Formation of Electron Transporting Layer>

On the formed light emission layer, LiF was vapor-deposited as an electron transporting layer forming material under the vacuum of 5×10⁴ Pa, and an electron transporting layer having a thickness of 0.5 nm was formed.

### <Formation of Cathode Electrode>

On the formed electron transporting layer, aluminum was vapor-deposited under the vacuum of 5×10⁻⁴ Pa, to form a cathode electrode having a thickness of 100 nm.

### <Formation of Sealing Film>

On the formed electron transporting layer, there was applied a flexible sealing member having a polyethylene terephthalate base on which was vapor-deposited Al₂O₃ with a thickness of 300 nm. In order to form external terminals for the anode electrode and the cathode electrode, the edge portion was eliminated and an adhesive agent was applied to the surrounding area of the cathode electrode. After sticking the flexible sealing member, the adhesive agent was cured with heating treatment.

[Uniformity of Luminescent Brightness]

Direct current voltage was impressed to the organic EL element to allow to emit light using Source Major Unit 2400 made by KEITHLEY Instrument Inc. For the organic EL elements EL-1A to EL-1M which were made to emit light with 200 cd, each luminescence uniformity was observed with a microscope at magnification of 50 times.

The evaluation criteria of luminescence uniformly

A: the whole EL element emits light uniformly
B: the whole EL element is emits light almost uniformly
C: slight ununiformity of luminescence in EL element is observed
D: markedly ununiformity of luminescence in EL element is observed
E: no luminescence in EL element is observed

The above-mentioned evaluation results are shown in Table 1.

TABLE 1

| Sample | Exposure | | | | |
|---|---|---|---|---|---|
| name of | property | | | Sample | Uniformity |
| Transparent | of | | | name | of |
| conductive | conductive | Surface | | of EL | lumines- |
| film | fiber | roughness | Attribute | element | cence |
| TC-1A | C | A | Invention | EL-1A | C |
| TC-1B | B | A | Invention | EL-1B | B |
| TC-1C | A | A | Invention | EL-1C | A |
| TC-1D | A | A | Invention | EL-1D | A |
| TC-1E | A | B | Invention | EL-1E | A |
| TC-1F | A | C | Invention | EL-1F | B |
| TC-1G | A | D | Comparison | EL-1G | D |
| TC-1H | A | D | Comparison | EL-1H | E |
| TC-1I | D | B | Comparison | EL-1I | E |
| TC-1J | A | D | Comparison | EL-1J | E |
| TC-1K | C | D | Comparison | EL-1K | E |
| TC-1L | D | B | Comparison | EL-1L | D |
| TC-1M | D | B | Comparison | EL-1M | D |

The following can be shown from the above-described results listed in Table 1.

From the evaluation results of exposure property of conductive fiber and surface roughness obtained from each transparent conductive film sample, transparent conductive films TC-1A to TC-1F are inventive samples of the present invention. The organic EL elements which used the transparent conductive film of the present invention as the transparent electrode gave excellent luminescent characteristic.

With respect to TC-1J to TC-1M which were prepared in accordance with the conventional method, when the coating thickness of the transparent resin which overcoats the conductive fiber is thin, the conductive fiber is exposed to the surface of the transparent conductive film, but,

since irregularity by an overlap of the conductive fibers affects the smoothness of the surface of the transparent conductive film, it cannot be function as a transparent electrode in the organic EL element which required to have high smoothness of a surface of an electrode.

On the other hand, when the coating thickness of the transparent resin which overcoats the conductive fiber is thickened, the smoothness of the surface of the transparent conductive film will be improved, but, since the conductive fibers are buried in the transparent resin, the conductive fibers will not be exposed to the surface of the transparent conductive film, as a result, the conductivity homogeneity on the surface of an electrode will falls, and uniform luminescence will not be obtained in an organic EL element.

Transparent conductive film samples TC-1A to TC-1H which were prepared, in accordance with the production method of the present invention, by transferring the conductive fiber layer containing a soluble binder. They are shown to have an excellent exposure property of the conductive fibers on the surface of the transparent conductive film. However, when the thickness of the soluble binder is made to be larger than the average diameter of the conductive fiber, the smoothness of the surface of the transparent conductive film will be deteriorated, and uniform luminescence will not be obtained in an organic EL element. This is considered to be attributed to the fact that the conductive fibers will be appeared in the separated state from the transparent resin after removal of the soluble binder.

Moreover, transparent conductive film sample TC-1I was prepared without using the soluble binder in accordance with a conventional method. In this case, since the transparent resin used as an adhesive layer at the time of transfer will cover conductive fibers, the conductive fibers cannot be exposed to the surface of the transparent conductive film, and it cannot be function as a transparent electrode.

### DESCRIPTION OF SYMBOLS

11: Transparent conductive film
21: Transparent substrate
31: Transparent resin layer
32: Transparent resin layer
33: Transparent resin layer
41: Conductive fiber
51: Conductive fiber layer
61: Functional layer
71: Mold-releasing substrate
81: Film made of soluble binder

1. A transparent conductive film comprising a transparent substrate having thereon a conductive fiber layer containing at least a transparent resin and a conductive fiber,
wherein at least a part of the conductive fiber is exposed on a surface of the transparent conductive film, and a relationship between a surface roughness (Rz) of the transparent conductive film and an average diameter (D) of the conductive fiber satisfies the inequalities of 0<Rz<D.

2. The transparent conductive film described in claim 1,
wherein the conductive fiber is selected from the group consisting of metal nanowires.

3. A method of producing the transparent conductive film of claim 1 comprising the steps of:
forming a conductive fiber layer containing a conductive fiber and a soluble binder on a mold-releasing surface of a mold-releasing substrate;
transferring the conductive fiber layer onto a transparent substrate using an adhesive agent to form a transparent conductive film; then
removing at least a part of the soluble resin from a surface of the transparent conductive film.

4. A method of producing the transparent conductive film of claim 3,
wherein a relationship between a thickness (d) of the conductive fiber layer formed by the soluble binder and the average diameter (D) of the conductive fiber satisfies the inequalities of 0<d<D.
